(19) United States
(12) Patent Application Publication
(10) Pub. No.: US 2015/0125211 A1
(43) Pub. Date: May 7, 2015

(54) BOOM AND METHOD OF FABRICATING THE SAME

(71) Applicant: Cerex Advanced Fabrics, Inc., Cantonment, FL (US)

(72) Inventors: Albert E. ORTEGA, Pensacola, FL (US); Daniel BAILLIE, Pensacola, FL (US)

(21) Appl. No.: 14/517,466

(22) Filed: Oct. 17, 2014

Related U.S. Application Data
(60) Provisional application No. 61/900,210, filed on Nov. 5, 2013.

(51) Int. Cl. E02B 15/06; B32B 37/04

(52) U.S. Cl. CPC E02B 15/06; B32B 37/04; B32B 2323/10; B32B 2367/00; B32B 2377/00
USPC 405/63; 156/218

(57) ABSTRACT

Strong fabrics can be used to fabricate booms that can be moved or gathered without the use of ropes or nettings. Methods are provided that can simplify the fabrication of these booms and provide a means of attaching booms to each other or to another structure or device. Materials that pass the criteria for NSF/ANSI Standard 61 and/or the criteria for SW-846 can be used to fabricate the sleeve for a boom.

### CROSS-REFERENCE TO A RELATED APPLICATION

This application claims the benefit of U.S. provisional application Ser. No. 61/900,210, filed Nov. 5, 2013, which is hereby incorporated herein by reference in its entirety.

### FIELD OF THE INVENTION

This invention relates to advantageous booms and efficient methods of fabricating a boom. A boom can be made without netting or rope or without both. Fewer materials and fewer fabrication steps are required.

### BACKGROUND

In related art methods of making booms, a sleeve is initially sewn from a roll of fabric by folding it longitudinally and then seaming the open edge. This tube is then filled with absorbent material and tied off at each end. Different fastening systems such as rings, rope, or ties can be used to close the ends of the tube. A rope is threaded longitudinally within the tube and then netting is used to cover the tube and keep the rope adjacent to the tube. Inclusion of the rope within the netting provides adequate tensile strength to the boom so that the boom may be pulled or held in position without breaking or moved without tearing. The netting is used to hold the rope and to fasten a clip or chain link to the rope through the netting to attach one boom to the next. Typically, two links or clips are attached to the booms, each about 16 to 18 inches from each end of the boom. The rope is threaded through a ring and clips or links to provide the capability to attach one boom to the next to create a barrier to capture and contain oil or spilled material. Covering the filled sleeve with netting requires an additional fabrication step as does inserting the rope in the boom.

### BRIEF SUMMARY

Embodiments of the subject invention provide strong fabrics that have sufficient tensile strength to eliminate the need for rope and netting when fabricating a boom. Strong fabrics can provide adequate tensile strength that is required when booms are moved or gathered, allowing for booms that do not have or need netting or rope.

Embodiments also provide methods of fabricating a boom. Methods of the subject invention can eliminate the need for netting or rope (and can utilize no such netting or rope), while still providing a way to connect booms to one another.

### BRIEF DESCRIPTION OF THE DRAWINGS

FIG. 1 shows an image of fabric folded over an unsewn edge according to an embodiment of the subject invention.

FIG. 2 shows an image of a folded edge and a sewn edge according to an embodiment of the subject invention.

FIG. 3 shows an image of grommet-positioning on a fabric according to an embodiment of the subject invention.

### DETAILED DISCLOSURE

Embodiments of the subject invention provide more efficient (than in the related art) methods of fabricating absorbent booms, as well as booms that require fewer materials for fabrication. It is an object of this invention to eliminate the need for rope in the fabrication and use of a boom. It is another object of this invention to eliminate the need for netting around a boom. It is still another object of this invention to continue to provide a way to attach one boom to another. It is yet another object of the invention to use fabric for the sleeve of a boom that will pass the criteria for NSF/ANSI Standard 61 and the criteria for SW-846 (United States EPA SW-846). The NSF/ANSI Standard 61 can be NSF/ANSI Standard 61-2007a, and the SW-846 can be SW-846, Third Edition.

In an embodiment, a specific width of fabric is used to make a boom sleeve by folding it longitudinally and seaming it as in the prior art. Sleeves for booms can then be created with various combinations of folds, grommets, rope or netting. Netting or rope or both are not required when using a strong fabric for the fabrication of the boom sleeve. That is, a boom can include no rope, no netting, or no rope and no netting. For example, in one embodiment another fold can be placed in the edge with the seam and another seam can be installed creating a strong strip that is four layers thick. Grommets can then be installed in this seam. This sleeve can then be filled with absorbent material such as shredded polypropylene melt blown fabric and made into a boom. Optionally, a rope can be added by creating a loop through the hole of the grommet and a bull ring with a ¾-inch diameter hole. A link or clip can then be used to connect booms to each other or a wall or some other structure or device. Optionally, the rope can be omitted and netting can be used to surround the boom. A clip or link can then be attached to the netting and/or through the sleeve fabric and then used to attach the booms to each other or another device. The netting can also be used to hook the boom with a gaffe or similar device.

In another embodiment, a boom sleeve can be created by folding a fabric longitudinally and seaming it. Another fold can be placed in the edge with the seam and another seam can be installed creating a strong strip that is four layers thick. Grommets can then be installed in this seam. The edge that is opposite the seam can then be folded over about an inch or an inch and a half and seamed longitudinally creating a strong strip of four layers of fabric. This sleeve can then be filled with absorbent material such as shredded polypropylene melt blown fabric and made into a boom. Grommets can then be attached in the strips providing a means to attach the boom to another boom or a vessel, seawall or some other structure or device on both sides of the boom.

In another embodiment, a sleeve can be made from a fabric by folding it in half and then sewing a longitudinal seam on the opposite edge of the fold. The edge that is opposite the seam can then be folded over about an inch or an inch and a half and seamed longitudinally creating a strong strip of four layers of fabric. Grommets can then be attached in this strip providing a means to attach the boom to another boom or a vessel, seawall or some other structure or device.

In another embodiment, nylon spunbonded fabrics can be used as a sleeve to provide strength to the boom. Nylon spunbond fabrics will soak up oil and other hydrocarbons. Nylon is also known to be chemically resistant to hydrocarbons, like gasoline. Other polymers such as polyethylene, polypropylene and polyesters are not as chemically resistant to petroleum products as nylon. This will create a shelf life problem if materials made with these other polymers are stored over extended periods where petroleum or hydrocarbon compounds are in the atmosphere or environment. Suitable spunbond nylon fabrics are available under the trade name Oil Shark®, Cerex®, PBN-II®, Orion® and SpectraMax® from Cerex Advanced Fabrics in Cantonment, Fla. Fabrics used to make boom sleeves according to embodiments of the subject invention can remove sheen (e.g., oil sheen) from water. Oil sheen on water is defined as oil on top of water that settles as a thin film layer that shimmers because of an optical phenomenon called interference. The shimmering can be in different colors. Sheen in general is when a substance is on top of water and settles as a thin film layer that shimmers because of interference. The shimmering can be in different colors. Fabrics of the subject invention surprisingly remove sheen from water, including removing oil sheen from an oil and water mixture. Such fabrics can include nylon, polyester, polyethylene, polypropylene, or any combination thereof, though embodiments are not limited thereto. Such fabrics can be spunbond fabrics, though embodiments are not limited thereto. Such fabrics can also be made from bicomponent or multicomponent filaments or bicomponent or multicomponent spinning processes. For example, a fabric that removes sheen from water of an oil and water mixture can be a nylon spunbond fabric, a polyester spunbond fabric, a polypropylene spunbond fabric, or a spunbond fabric made from a combination of at least two of nylon, polyester, and polypropylene.

In yet another embodiment, a fabric that is less permeable to spilled material can be used to contain the spill and recover or absorb the material at a later time. A sheet of about six to 60 inches can be extended from the bottom of the boom providing a barrier to spilled material preventing further spreading of the material. Nylon is a particularly preferred material since it has a specific gravity higher than 1 and would stay under the surface of the water once it is wet or with minimal additional weight to overcome any buoyancy effect. The fabric can be a nylon spunbond that is thermally bonded with the pattern illustrated in registered United States Trademark 2,163,116. This fabric is sold under the trademarks PBN-II® and OIL SHARK® and is available from Cerex Advanced Fabrics, Inc. Other patterns can be used. Examples of fabrics that can be used with other patterns are a diamond patterned fabric sold under the trademarks ORION® and OIL SHARK® available from Cerex Advanced Fabrics, Inc. and a herringbone patterned fabric sold under the trademarks SPECTRAMAX® and OIL SHARK® available from Cerex Advanced Fabrics, Inc. Other polymers or combination of polymers can be used to make the fabric including but not limited to polyester and polypropylene. For example, a fabric can be made from nylon, polyester, polypropylene, or any combination thereof, though embodiments are not limited thereto.

In yet another embodiment, a fabric that will remove sheen (e.g., oil sheen) can be used as a sweep by attaching the fabric to a boom or extending one or both edges of the boom sleeve made according to the subject invention. Sweeps are fabrics with a seamed edge and a rope or band attached to at least one edge. The sweeps are then passed on the surface of the water to capture and remove spilled crude oil from the environment. These items can lose integrity when deployed and exposed to oil, making them difficult to gather and collect after they have absorbed oil. They also can easily break or disintegrate since they have such low strength when pulled or dragged in the field, creating difficulties when crews are cleaning up oil spills. When using polypropylene fabrics to fabricate sweeps, a band is typically added to one or more longitudinal edges and vertical edges to give the sweep more strength for pulling or dragging and to prevent or inhibit disintegration when the sweep becomes wet with oil. This adds cost and adds at least one additional fabrication step. In addition, items made from these polypropylene fabrics are not very effective at removing oil sheen on the surface of water, and pads made from polypropylene melt blown fabrics are not very effective at removing oil sheen. For example, two layers of fabric can be used with a seam on both longitudinal edges. A stitch bonding machine can be used to fabricate tubes of any desired width from two layers of fabric. An additional strip or strips can be created that will act as a sweep along a longitudinal edge. This sweep can be of any width such as but not limited to about 1 inch, about 1 inch to about 3 inches, about 3 inches to about 7 inches, about 7 inches to about 11 inches, about 11 inches to about 15 inches, about 15 inches to about 19 inches, about 19 inches to about 23 inches, about 23 inches to about 27 inches, about 27 inches to about 31 inches, about 31 inches to about 35 inches, about 35 inches to about 39 inches, about 39 inches to about 43 inches, about 43 inches to about 47 inches, about 47 inches to about 51 inches, about 51 inches to about 55 inches, about 55 inches to 59 inches, about 59 inches to 63 inches or more than 63 inches.

A fabric (e.g., a nonwoven fabric such as a spunbond fabric) used in a boom can have an air permeability of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in cubic feet per minute/square foot (cfm/ft²)): 30, 35, 40, 41, 42, 43, 44, 45, 50, 60, 70, 80, 90, 98, 100, 200, 300, 400, 500, 600, 675, 700, 800, 900, 1000, 1100, 1200, 1300, 1400, 1500, 1600, 1700, 1800, 1900, 2000, 2100, 2200, 2300, 2400, 2410, 2420, 2430, 2440, 2450, or 2500. For example, a fabric can have an air permeability of at least 98 cfm/ft². Such a fabric can be a nonwoven fabric (e.g., a spunbond fabric) including nylon, polyester, polypropylene, or some combination thereof. In a particular embodiment, a fabric of a boom of the subject invention can have an air permeability of at least 675 cfm/ft².

A sweep of the subject invention, as discussed above, can have a width of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in inches): 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, or 63. For example, a sweep can have a width in a range of from about 1 inch to about 63 inches. In an embodiment, a sweep can have a width of at least 63 inches.

In an embodiment, a length of 25 inch wide 2 ounce per square yard (osy) nylon spunbond fabric is seamed longitudinally to create a 12.5 inch wide tube. Suitable spunbond nylon fabrics are available under the trade name Oil Shark®, Cerex®, PBN-II®, Orion®, Spectralon®, Vibratex® and Spectramax® from Cerex Advanced Fabrics, Inc. in Cantonment, Fla. The fabric used in this embodiment can have one or more of the following properties: a thickness of about 15 mils as measured by ASTM D1777; an air permeability of about 350 cubic feet per minute per square foot (cfm/ft²) as measured by ASTM D737; a machine direction grab strength of about 70 pounds force as measured by ASTM D5034; a machine direction grab elongation of about 80% as measured by ASTM D5034; a cross direction grab strength of about 52 pounds force as measured by ASTM D5034; a cross direction grab elongation of about 89% as measured by ASTM D5034; and a burst strength of about 60 pounds per square inch as measured by ASTM D3786. Other fabrics of various basis weights, constructions, and polymers or combinations of polymers, for example, spunbond, knit, woven, or needle punched polyester or polypropylene fabrics, can be used as long as they provide adequate tensile strength. A fabric with at least a machine direction grab strength of about 20 pounds force as measured by ASTM D5034, at least a cross direction grab strength of about 9 pounds force as measured by ASTM D5034 and at least a burst strength of about 19 pounds per square inch as measured by ASTM D3786 will provide adequate strength for effective use.

About one inch of the edge opposite of the seam can then be folded over in the longitudinal length and seamed. This creates about a 1-inch strip that is four layers thick or in the case of this preferred embodiment, a layer that is 8 ounces per square yard in basis weight that can easily accommodate a grommet. At least two grommets are installed in this strip, two of them each approximately 16 inches from the edge of the tube. Grommets can be of any diameter and the width of the strip can be adjusted to accommodate grommets of a particular diameter. In a preferred embodiment, a grommet with a ½-inch diameter hole is used. One skilled in the art will realize that the width of the folded edge can be modified, the basis weight can be modified, the diameter, position and number of grommets can be modified and several other design parameters can be changed. For example, two layers of fabric can be used with a seam on both longitudinal edges. A stitch bonding machine can be used to fabricate tubes of any desired width from two layers of fabric. An additional narrower strip or tube, for example that is two inches wide, can be sewn along one longitudinal seam that will accommodate a rope or grommets

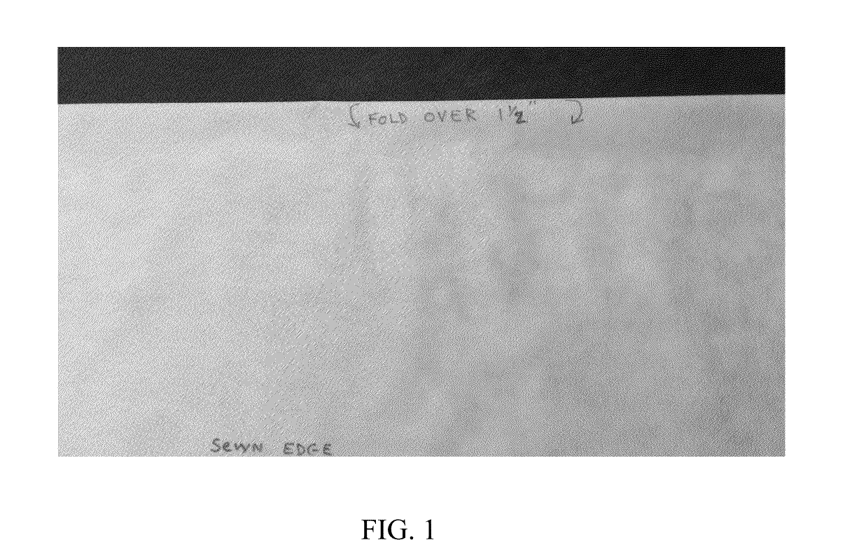

FIG. 1 shows an image of fabric folded over an unsewn edge according to an embodiment of the subject invention. Referring to FIG. 1, a fabric can be folded over an unsewn edge, and such a fold (top of image) can be opposite to a sewn edge (bottom of image). The fold can be, for example, 1.5 inches, though embodiments are not limited thereto.

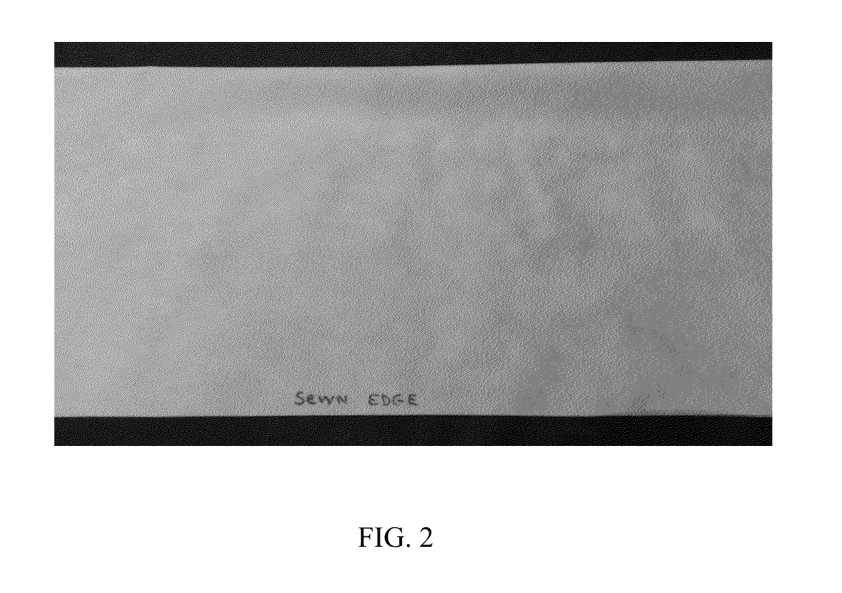

FIG. 2 shows an image of a folded edge and a sewn edge according to an embodiment of the subject invention. Referring to FIG. 2, the folded edge (top of image) can be opposite to the sewn edge (bottom of image).

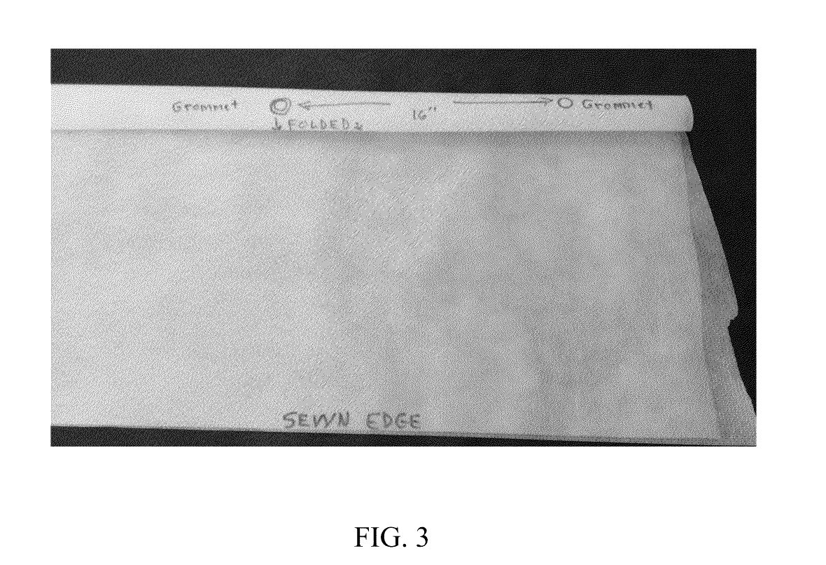

FIG. 3 shows an image of grommet-positioning on a fabric according to an embodiment of the subject invention. Referring to FIG. 3, in an embodiment, two grommets can be present on a folded edge (top of image) of a fabric. Such a folded edge can be opposite to a sewn edge (bottom of image). The two grommets can be, for example, 16 inches or about 16 inches apart, though embodiments are not limited thereto. In further embodiments, two grommets can be spaced at least 16 inches or no more than 16 inches apart.

It will be apparent to the skilled artisan having the benefit of the instant disclosure that the invention is susceptible to numerous variations and modifications within its spirit and scope.

When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

### EXEMPLIFIED EMBODIMENTS

The invention includes, but is not limited to, the following embodiments:

### Embodiment 1

A boom comprising a fabric, wherein the fabric has a minimum machine direction grab tensile strength of 20 lbs_{f} as measured by ASTM D5034.

### Embodiment 2

The boom according to embodiment 1, wherein the fabric has a minimum cross direction grab strength of 9 lbs_{f} as measured by ASTM D5034.

### Embodiment 3

The boom according to any of embodiments 1-2, wherein the fabric has a minimum burst strength of 19 psi (pounds per square inch) as measured by ASTM D3786.

### Embodiment 4

The boom according to any of embodiments 1-3, wherein the fabric passes the criteria for NSF/ANSI Standard 61, the criteria for United States EPA SW-846, or both (The NSF/ANSI Standard 61 can be NSF/ANSI Standard 61-2007a, and the SW-846 can be SW-846 (Third Edition)).

### Embodiment 5

The boom according to any of embodiments 1-4, wherein the boom comprises a sleeve and a sleeve fabric used for the sleeve of the boom, wherein the sleeve fabric passes the criteria for NSF/ANSI Standard 61, the criteria for SW-846, or both (The NSF/ANSI Standard 61 can be NSF/ANSI Standard 61-2007a, and the SW-846 can be SW-846 (Third Edition)).

### Embodiment 6

The boom according to embodiment 5, wherein the sleeve fabric has a minimum machine direction grab tensile strength of 20 lbs_{f} as measured by ASTM D5034.

### Embodiment 7

The boom according to any of embodiments 5-6, wherein the sleeve fabric has a minimum cross direction grab strength of 9 lbs_{f} as measured by ASTM D5034.

### Embodiment 8

The boom according to any of embodiments 5-7, wherein the sleeve fabric has a minimum burst strength of 19 psi (pounds per square inch) as measured by ASTM D3786.

### Embodiment 9

The boom according to any of embodiments 1-8, wherein the boom uses no rope.

### Embodiment 10

The boom according to any of embodiments 1-8, wherein the boom comprises no rope.

### Embodiment 11

The boom according to any of embodiments 1-10, wherein the boom uses no netting.

### Embodiment 12

The boom according to any of embodiments 1-10, wherein the boom comprises no netting.

### Embodiment 13

The boom according to any of embodiments 1-12, wherein the boom has a seamed edge and a folded edge opposite the seamed edge.

### Embodiment 14

The boom according to embodiment 13, wherein the boom comprises at least one grommet in the folded edge.

### Embodiment 15

The boom according to embodiment 13, wherein the boom comprises at least two grommets in the folded edge.

### Embodiment 16

The boom according to any of embodiments 1-13, wherein the boom comprises at least one grommet.

### Embodiment 17

The boom according to any of embodiments 1-13, wherein the boom comprises at least two grommets.

### Embodiment 18

The boom according to any of embodiments 1-17, wherein the boom comprises a colored sleeve.

### Embodiment 19

The boom according to any of embodiments 5-8, wherein the sleeve is colored.

### Embodiment 20

A method of fabricating a boom with at least one folded edge.

### Embodiment 21

The method according to embodiment 20 wherein the method comprises fabricating the boom, and folding at least one edge of the boom to fabricate the at least one folded edge.

### Embodiment 22

The method according to any of embodiments 20-21, wherein the method comprises fabricating a seamed edge opposite to a folded edge of the at least one folded edge of the boom.

### Embodiment 23

The method according to any of embodiments 20-22, wherein the method comprises installing at least one grommet in a folded edge of the at least one folded edge.

### Embodiment 24

The method according to any of embodiments 20-22, wherein the method comprises installing at least two grommets in a folded edge of the at least one folded edge.

### Embodiment 25

The method according to any of embodiments 20-22, wherein the method comprises installing at least one grommet in the boom.

### Embodiment 26

The method according to any of embodiments 20-22, wherein the method comprises installing at least two grommets in the boom.

### Embodiment 27

The method according to any of embodiments 20-26, wherein the boom comprises a fabric, and wherein the fabric has a minimum machine direction grab tensile strength of 20 lbs_{f} as measured by ASTM D5034.

### Embodiment 28

The method according to embodiment 27, wherein the fabric has a minimum cross direction grab strength of 9 lbs_{f} as measured by ASTM D5034.

### Embodiment 29

The method according to any of embodiments 27-28, wherein the fabric has a minimum burst strength of 19 psi (pounds per square inch) as measured by ASTM D3786.

### Embodiment 30

The method according to any of embodiments 27-29, wherein the fabric passes the criteria for NSF/ANSI Standard 61-2007a, and the criteria for SW-846 (Third Edition), or both.

### Embodiment 31

The method according to any of embodiments 27-30, wherein the boom comprises a sleeve and a sleeve fabric used for the sleeve of the boom, wherein the sleeve fabric passes the criteria for NSF/ANSI Standard 61-2007a, the criteria for SW-846 (Third Edition), or both.

### Embodiment 32

The method according to embodiment 31, wherein the sleeve fabric has a minimum machine direction grab tensile strength of 20 lbs_{f} as measured by ASTM D5034.

### Embodiment 33

The method according to any of embodiments 31-32, wherein the sleeve fabric has a minimum cross direction grab strength of 9 lbs_{f} as measured by ASTM D5034.

### Embodiment 34

The method according to any of embodiments 31-33, wherein the sleeve fabric has a minimum burst strength of 19 psi (pounds per square inch) as measured by ASTM D3786.

### Embodiment 35

The method according to any of embodiments 27-34, wherein the boom uses no rope.

### Embodiment 36

The method according to any of embodiments 27-34, wherein the boom comprises no rope.

### Embodiment 37

The method according to any of embodiments 27-36, wherein the boom uses no netting.

### Embodiment 38

The method according to any of embodiments 27-36, wherein the boom comprises no netting.

### Embodiment 39

The method according to any of embodiments 27-38, wherein the boom comprises a colored sleeve.

### Embodiment 40

The boom according to any of embodiments 31-34, wherein the sleeve is colored.

### Embodiment 41

The boom according to any of embodiments 1-19 wherein the fabric used to make the sleeve removes oil sheen on water (e.g., from an oil and water mixture).

### Embodiment 42

A method of deploying a boom in an oil spill in water, wherein the boom removes oil sheen from the water.

### Embodiment 43

A method of deploying a boom in an oil spill in water, wherein the boom is the boom according to any of embodiments 1-19 and 41.

### Embodiment 44

The boom according to any of embodiments 1-19 and 41, wherein the fabric comprises nylon, polyester, polypropylene, or a combination thereof.

### Embodiment 45

The boom according to any of embodiments 1-19, 41, and 44, wherein the fabric is a spunbond, needle punch, knit, or woven fabric.

### Embodiment 46

The boom according to any of embodiments 1-19, 41, 44, and 45, wherein the fabric has an air permeability of at least 98 cubic feet per minute per square foot (cfm/ft²).

### Embodiment 47

The boom according to any of embodiments 1-19, 41, and 44-46, further comprising at least one grommet and at least one edge having one fold.

### Embodiment 48

The boom according to any of embodiments 1-19, 41, and 44-47, wherein the fabric comprises nylon, polyester, polypropylene, or a combination thereof, wherein the fabric is a spunbond, nonwoven fabric, wherein the boom does not include any rope, and wherein the boom does not include any netting.

### Embodiment 49

A method of fabricating a boom, comprising fabricating a boom sleeve nonwoven fabric for the boom, wherein fabricating the boom sleeve nonwoven fabric comprises:

feeding and spinning, in an extruder, one or more polymer resins;

extruding the one or more polymer resins in the form of a plurality of filaments;

depositing the filaments onto a collection surface to form a web; and

thermally bonding the filaments of the web to form the nonwoven fabric, and

wherein the nonwoven fabric has a machine grab direction tensile strength of at least 20 lbs_{f} as measured by ASTM D5034.

### Embodiment 50

The method according to embodiment 49, further comprising folding the nonwoven fabric and seaming the nonwoven fabric.

### Embodiment 51

The method according to embodiment 50, further comprising attaching the folded, seamed, nonwoven fabric to another device using a fastener, wherein the boom comprises a grommet, and wherein the fastener is attached through the grommet of the boom.

### Embodiment 52

The method according to any of embodiments 48-51, wherein the fabric passes the criteria for NSF/ANSI Standard 61, the criteria for United States EPA SW-846, or both (The NSF/ANSI Standard 61 can be NSF/ANSI Standard 61-2007a, and the SW-846 can be SW-846 (Third Edition)).

### Embodiment 53

The method according to any of embodiments 48-52, wherein the nonwoven fabric comprises nylon, polyester, polypropylene, or a combination thereof.

### Embodiment 54

The method according to any of embodiments 48-53, wherein the nonwoven fabric removes oil sheen from water.

### Embodiment 55

The method according to any of embodiments 48-52 and 54, wherein the nonwoven fabric comprises nylon, polyester, or a combination thereof.

### Embodiment 56

The method according to any of embodiments 48-55, wherein the boom does not include any rope.

### Embodiment 57

The method according to any of embodiments 48-56, wherein the boom does not include any netting.

### Embodiment 58

The method according to any of embodiments 48-57, wherein the fabric has a minimum cross direction grab strength of 9 lbs_{f} as measured by ASTM D5034.

### Embodiment 59

The method according to any of embodiments 48-58, wherein the fabric has a minimum burst strength of 19 psi (pounds per square inch) as measured by ASTM D3786.

### Embodiment 60

The method according to any of embodiments 48-59, wherein the fabric has an air permeability of at least 98 cfm/ft².

### Embodiment 61

The method according to any of embodiments 48-59, wherein the fabric has an air permeability of at least 675 cfm/ft².

### Embodiment 62

The boom according to any of embodiments 1-19, 41, 44, 45, 47, and 48, wherein the fabric has an air permeability of at least 675 cfm/ft².

Following are examples that illustrate embodiments of the invention and/or procedures for practicing the invention. These examples should not be construed as limiting.

### Example 1

Ten feet of 25 inch wide 2 ounce per square yard (osy) spunbond nylon fabric Type 30 PBN-II® available from Cerex Advanced Fabrics, Inc. in Cantonment, Fla. is seamed longitudinally to create a 12.5 inch wide tube. This fabric has a thickness of about 15 mils as measured by ASTM D1777, an air permeability of about 350 cfm/ft² as measured by ASTM D737, a machine direction grab strength of about 70 pounds force as measured by ASTM D5034, a machine direction grab elongation of about 80% as measured by ASTM D5034, a cross direction grab strength of about 52 pounds force as measured by ASTM D5034, a cross direction grab elongation of about 89% as measured by ASTM D5034 and a burst strength of about 60 pounds per square inch as measured by ASTM D3786. When scoured, this fabric will pass the criteria for NSF/ANSI Standard 61-2007a (can be found at www.nsf.org), which is the nationally (in the United States) recognized health standard for all devices, components, and materials that contact drinking water. This fabric will also pass the criteria for SW-846, Third Edition, which is the EPA standard for allowing wastes to be treated as non-hazardous waste.

One inch of the edge opposite of the seam is then folded over in the longitudinal length and seamed. This creates a 1-inch strip that is four layers thick or 8 osy in basis weight that can easily accommodate a grommet. Two grommets with ½-inch holes are installed in this strip each approximately 16 inches from the edge of the tube. The tube is then filled with shredded absorbent polypropylene fabric strips and sealed at each end with a metal clip and a bull ring is attached to each end of the boom.

### Example 2

Ten feet of 25 inch wide 2 ounce per square yard (osy) spunbond nylon fabric Type 37 Blue Spectralon® available from Cerex Advanced Fabrics, Inc. in Cantonment, Fla. is seamed longitudinally to create a 12.5 inch wide tube. The same steps were followed as Example 1 to create a sleeve that is identical to the one in Example 1 except that it is blue.

### Example 3

Ten feet of 25 inch wide 4 ounce per square yard (osy) spunbond nylon fabric Type QG Orange Spectralon® fabric available from Cerex Advanced Fabrics, Inc. in Cantonment, Fla. is seamed longitudinally to create a 12.5 inch wide tube. The same steps were followed as Example 1 to create a sleeve that is identical to the one in example 1 except that it is orange and has a basis weight of 4 osy. This fabric is a thermally bonded nylon spunbond fabric with the pattern illustrated in registered United States Trademark 2,163,116. Solvent dyes are used to impart the orange color. These dyes do not contain lead or metallic chromium. When scoured, this fabric will pass the criteria for NSF/ANSI Standard 61-2007a (can be found at www.nsf.org), which is the nationally (in the United States) recognized health standard for all devices, components, and materials that contact drinking water. This fabric will also pass the criteria for SW-846, Third Edition, which is the EPA standard for allowing wastes to be treated as non-hazardous waste.

Physical properties of the fabric were measured and are listed in Table 1 below. This fabric was exposed to a xenon light source and water spray as described in ASTM D4355. Grab tensile properties were measured initially and at 150, 300, and 500 hours of exposure time. The results are shown in Table 2. The flux and filter efficiency performance of an identical 4 osy fabric made with no dyes, Type 30, is listed in Table 3. The flux of the 4 osy orange fabric, QG, will be similar to the fabric listed in Table 3 that is made the same way as this fabric but without dyes. Mean pore size, tensile strength retention after exposure to a xenon light source for 1000 hours using ASTM D5034 was measured on the 4 osy Type 30 fabric which is identical to the orange Type QG fabric but contains no dyes. The mean pore size, tensile strength retention after exposure to a xenon light source for 1000 hours using ASTM D5034 of the 4 osy orange Type QG fabric will be similar to this 4 osy Type 30 fabric made with no dyes and is listed in Table 4. This fabric, QG, originally has an orange color close to Pantone® 159C. The fabric retained its orange color and became a lighter orange color close to Pantone® 472C after 500 hours of exposure to a xenon light source and water spray as described in ASTM D4355-07. The orange color retention is a surprising result since many dyes do not exhibit good colorfastness.

TABLE 1
Typical Physical properties of 4 ounce
per square yard orange fabric QG400

| Physical Property | ASTM | Units | Average |
|---|---|---|---|
| Basis Weight | D3776 | Ounces/yd² | 4.07 |
| Thickness | D1777 | Mils | 22.9 |
| Textest Air Permeability | D737 | ft³/minute/ft² | 98 |
| Machine Direction Grab Strength | D5034 | lb_{f} | 149.6 |
| Machine Direction Grab Elongation | D5034 | % | 90.1 |
| Cross Direction Grab Strength | D5034 | lb_{f} | 119.3 |
| Cross Direction Grab Elongation | D5034 | % | 98.6 |
| Machine Direction Trapezoidal | D5587 | lb_{f} | 40.8 |
| Strength | | | |
| Cross Direction Trapezoidal | D5587 | lb_{f} | 26.1 |
| Strength | | | |
| Burst Strength | D3786 | Lb./in² | 116.6 |
| Density | calculated | g/cm³ | 0.231 |

TABLE 2
Tensile properties of orange fabric QG400 after xenon
light and water spray exposure as per ASTM D4355

| | | | 150 | 300 | 500 |
|---|---|---|---|---|---|
| | | No | Hours | Hours | Hours |
| | | expo- | expo- | expo- | expo- |
| Physical Property | Units | sure | sure | sure | sure |
| Machine Direction | lb_{f} | 141.6 | 112.3 | 63.8 | 45.7 |
| Grab Strength | | | | | |
| Machine Direction | % | 121.9 | 97.6 | 33.9 | 24.3 |
| Grab Elongation | | | | | |
| Cross Direction | lb_{f} | 98.6 | 76.2 | 42.8 | 28.8 |
| Grab Strength | | | | | |
| Cross Direction | % | 133.8 | 99.8 | 43.1 | 29.6 |
| Grab Elongation | | | | | |

TABLE 3
ASTM D5141 Results for 4 osy Type 30 PBN-II ® fabric

| Replicate | Flux (gpm/ft2) | Filter Efficiency (%) |
|---|---|---|
| 1 | 0.94 | 99.5 |
| 2 | 0.91 | 99.1 |
| 3 | 1.20 | 99.3 |

TABLE 4
Typical Physical properties of 4 ounce per square yard Type 30

| Physical Property | ASTM | Units | Target |
|---|---|---|---|
| Basis Weight | D3776 | Ounces/yd² | 4 |
| Thickness | D1777 | Mils | 22.3 |
| Textest Air Permeability | D737 | ft³/minute/ft² | 125 |
| Machine Direction Grab Strength | D5034 | lb_{f} | 156.9 |
| Machine Direction Grab Elongation | D5034 | % | 91 |
| Cross Direction Grab Strength | D5034 | lb_{f} | 118.8 |
| Cross Direction Grab Elongation | D5034 | % | 100 |
| Machine Direction Trapezoidal | D5587 | lb_{f} | 49 |
| Strength | | | |
| Cross Direction Trapezoidal | D5587 | lb_{f} | 34.2 |
| Strength | | | |

TABLE 4
Typical Physical properties of 4 ounce per square yard Type 30

| Physical Property | ASTM | Units | Target |
|---|---|---|---|
| Burst Strength | D3786 | lb./in² | 109.4 |
| Machine Direction Grab Strength | D4632 | lb_{f} | 174.2 |
| Machine Direction Grab Elongation | D4632 | % | 115.1 |
| Cross Direction Grab Strength | D4632 | lb_{f} | 126.2 |
| Cross Direction Grab Elongation | D4632 | % | 112.6 |
| Mean pore size | | Microns | 31 |
| Machine Direction Grab Strength | D5034 | % | 87 |
| retention after exposed to xenon | | | |
| light for 1000 hours | | | |
| Density | Calculated | g/cm³ | 0.234 |

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

All patents, patent applications, provisional applications, and publications referred to or cited herein are incorporated by reference in their entirety, including all figures and tables, to the extent they are not inconsistent with the explicit teachings of this specification.

What is claimed is:

1. A boom comprising a fabric, wherein the fabric has a machine direction grab tensile strength of at least 20 pounds force (lbs_{f}) as measured by ASTM D5034.

2. The boom according to claim 1, wherein the fabric has a cross direction grab tensile strength of at least 9 lbs_{f} as measured by ASTM D5034.

3. The boom according to claim 2, wherein the fabric passes the criteria for United States EPA SW846, Third Edition.

4. The boom according to claim 2, wherein the fabric passes the criteria for NSF/ANSI Standard 61-2007a.

5. The boom according to claim 2, wherein the fabric removes oil sheen from water.

6. The boom according to claim 5, wherein the fabric comprises nylon, polyester, or a combination thereof,
wherein the fabric is a spunbond, nonwoven fabric,
wherein the boom does not include any rope, and
wherein the boom does not include any netting.

7. The boom according to claim 2, wherein the fabric comprises nylon, polyester, polypropylene, or a combination thereof.

8. The boom according to claim 2, wherein the fabric is a spunbond, needle punch, knit, or woven fabric.

9. The boom according to claim 2, wherein the fabric has an air permeability of at least 98 cubic feet per minute per square foot (cfm/ft²).

10. The boom according to claim 2, wherein the boom does not include any rope.

11. The boom according to claim 10, wherein the boom does not include any netting.

12. The boom according to claim 2, wherein the boom does not include any netting.

13. The boom according to claim 2, further comprising at least one grommet and at least one edge having one fold.

14. A method of fabricating a boom, comprising fabricating a boom sleeve nonwoven fabric for the boom, wherein fabricating the boom sleeve nonwoven fabric comprises:
feeding and spinning, in an extruder, one or more polymer resins;
extruding the one or more polymer resins in the form of a plurality of filaments;
depositing the filaments onto a collection surface to form a web; and
thermally bonding the filaments of the web to form the nonwoven fabric, and
wherein the nonwoven fabric has a machine grab direction tensile strength of at least 20 lbs_{f} as measured by ASTM D5034.

15. The method according to claim 14, further comprising folding the nonwoven fabric and seaming the nonwoven fabric.

16. The method according to claim 15, further comprising attaching the folded, seamed, nonwoven fabric to another device using a fastener, wherein the boom comprises a grommet, and wherein the fastener is attached through the grommet of the boom.

17. The method according to claim 14, wherein the nonwoven fabric passes the criteria for United States EPA SW846, Third Edition.

18. The method according to claim 14, wherein the nonwoven fabric comprises nylon, polyester, polypropylene, or a combination thereof.

19. The method according to claim 14, wherein the nonwoven fabric removes oil sheen from water.

20. The method according to claim 19, wherein the nonwoven fabric comprises nylon, polyester, polypropylene, or a combination thereof,
wherein the boom does not include any rope, and
wherein the boom does not include any netting.
